(19) United States
(12) Patent Application Publication
(10) Pub. No.: US 2026/0204158 A1
(43) Pub. Date: Jul. 16, 2026

(54) METHOD FOR DETERMINING A ROAD CONDITION

(71) Applicant: MERCEDES-BENZ GROUP AG, Stuttgart (DE)

(72) Inventors: Andreas PETROVIC, Stuttgart (DE); Jannis KIOURTSIDIS, Sindelfingen (DE)

(21) Appl. No.: 19/130,593

(22) PCT Filed: Oct. 11, 2023
(86) PCT No.: PCT/EP2023/078159

§ 371 Date: May 16, 2025

(30) Foreign Application Priority Data
Nov. 21, 2022 (DE) 10 2022 004 338.6

(51) Int. Cl. G08G 1/0967; G01C 21/34; G06V 10/774; G06V 20/10; G06V 20/13; G06V 20/56; G08G 1/01

(52) U.S. Cl. CPC G08G 1/096775; G01C 21/3461; G06V 10/774; G06V 20/13; G06V 20/182; G06V 20/588; G08G 1/0112; G08G 1/096708

(57) ABSTRACT

A road condition is determined using vehicles of a vehicle fleet connected to a central computer unit using data technology. Satellite images of the Earth's surface are received by the central computer unit. Image information of road surfaces is extracted from the received satellite images in the central computer unit by digital map data. Aa road condition of route sections of a respective road is determined from the extracted image information of the road surfaces by a learning algorithm.

### BACKGROUND AND SUMMARY OF THE INVENTION

Exemplary embodiments of the invention relate to a method for determining a road condition, wherein vehicles of a vehicle fleet are connected to a central computer unit using data technology.

A method and a device for predictive road condition detection by means of surroundings detection of a vehicle by at least one camera is known from DE 10 2019 006 384 A1. Here, reflections of the road surface are analyzed in the captured camera images. The information on reflections obtained from the camera images is transmitted to an external computing unit together with vehicle data of a rain sensor and/or a windscreen wiper. Thus, characteristic reflections and different road conditions are determined.

Moreover, DE 10 2020 005 185 A1 describes a method for estimating a road condition of a road in the surroundings of a motor vehicle by means of an electronic computing device external to the vehicle. Here, the road is detected as road information by means of a detection device of the motor vehicle, and the road information is transmitted to the electronic computing device external to the motor vehicle. The electronic computing device external to the motor vehicle has an artificial intelligence by means of which the road condition is estimated depending on the transmitted road information, wherein a future road condition is predicted by means of the artificial intelligence, depending on at least one parameter.

Furthermore, EP 1 273 496 A2 discloses a method for road classification in a vehicle, wherein translational movements of a vehicle wheel relative to a vehicle body and/or forces acting on a vehicle wheel are determined. An evaluation is carried out by means of the dynamic components of the movements of the vehicle wheel and/or the forces acting on the vehicle wheel above a predetermined limit frequency. By means of evaluation, a distinction is made between road types and/or road conditions.

A method is known from DE 10 2019 133 536 A1 in which a correction of map data and satellite images is provided by means of image information of vehicles.

A method is known from DE 10 2019 214 628 A1 in which it is provided to undertake a fusion of satellite image data and radar data and to draw on data from a vehicle sensor system to recognize the course of a road.

A method is known from DE 10 2006 051 539 A1 in which it is provided to supplement vehicle-related images by aerial images from satellite data.

A method is known from DE US 2020/0 023 835 A1 in which trajectories of vehicles on a carriageway or at a junction are learnt from satellite images and map data.

Exemplary embodiments of the invention are directed to a method for determining a road condition.

According to the invention, a method for determining a road condition, wherein vehicles of a vehicle fleet are connected to a central computer unit using data technology, provides that satellite images of the Earth's surface are received by means of the central computer unit. In the central computer unit, image information of road surfaces is extracted from the received satellite images by means of digital map data and a road condition of route sections of a respective road is determined from the extracted image information of the road surfaces by means of a learning algorithm.

A prediction of road conditions across a wide area is possible by means of the method, wherein the prediction is largely independent of locally measured data. The method makes it possible to predict the respective road condition by means of satellite images and to enrich them with real fleet data with a high degree of accuracy. Thus, the coverage for determining road conditions is also improved on comparatively low-traffic roads and provides relatively accurate data even without available fleet data. In addition, the robustness of the prediction model is iteratively trained and improved by real vehicle measurements, whereby the need for vehicle data can be increasingly reduced over time. In particular, incorrect measurements that are based on environmental influences such as shadows, wet conditions, etc. for example can be reduced.

By applying the method, information about the road condition of route sections is thus ascertained, which can be used to decide whether a respective road section is suitable for automated driving operation of a vehicle, in particular for highly automated or driverless driving operation. Based on the information ascertained about the road condition of a route section, it can be blocked at least temporarily for automated driving operation due to its road condition.

The information can also be used to adjust the driving dynamics of a vehicle that has this information, in particular with regards to driving speed and/or acceleration, to the road condition, in particular with an automatically driving vehicle. Thus it is possible to avoid damage to vehicles travelling on the route section as far as possible.

Moreover, if road damage is recognized when ascertaining the road condition, this can be reported, in particular transmitted, to the responsible authorities. Thus, the responsible body is informed and can rectify the road damage.

In an embodiment of the method, the algorithm is trained by means of ground truth data, which is recorded by the vehicles of the vehicle fleet as the above-mentioned fleet data when travelling on the respective route section and is transmitted to the central computer unit. Thus, a degree of accuracy of the algorithm for ascertaining the road condition of a respective route section can be improved.

In a further embodiment, a real road condition is determined by means of detected signals of a sensor system of the respective vehicle in the vehicle fleet. These detected signals are supplied to the central computer unit as fleet data and taken into consideration when determining the corresponding road condition, since this is real data, such that the accuracy of the determined road conditions can be optimized.

In a development of the method, a real road condition is determined by means of the detected vehicle system conditions of the respective vehicle of the vehicle fleet. For example, the road condition determined by means of the detected signals of the sensor system is checked for plausibility or details with the road condition determined by means of the vehicle system conditions. In particular, the real road condition is created by means of a combination of the road condition determined by the sensors and the road condition determined by means of the vehicle system conditions. Elevations and depressions in a surface of the route section can be ascertained by means of the determined vehicle system conditions.

A further possible embodiment provides that a friction coefficient of the respective route section is determined by means of a detected slip of a driven vehicle wheel of the respective vehicle of the vehicle fleet. For example, it is determined by means of the friction coefficient how a trajectory of an automatically driving vehicle is calculated. In particular, a conclusion about the condition of a surface of the route section, i.e., the surface over which the vehicle of the vehicle fleet is travelling, can be made by means of the friction coefficient. The central computer unit has general environmental data, such as information on weather conditions, for example, such that an actual friction coefficient can substantially be determined.

In a possible design of the method, a road condition model is created by means of fleet data of the vehicles of the vehicle fleet and a further road condition model is created by means of the satellite images, wherein a synchronized road condition model is created by means of the road condition models and further data. This means that a comparison is made between the road condition models and, optionally, map data is additionally used as further data in order to create the synchronized road condition model, which depicts the road conditions of route sections of the respective road and represents a comparatively robust basis, in particular for the release for automated driving operation, in particular highly automated or driverless driving operation of vehicles.

In a further embodiment, the synchronized road condition model is made available at least to the vehicles of the vehicle fleet by means of the central computer unit, such that, for example, settings for the driving dynamics of the respective vehicle can be adjusted, for example on a route section with road damage. Thus, it is possible to at least reduce damage to the vehicle, for example due to driving through a pothole.

In one embodiment, determined information about the road condition is used to decide whether to release or block route sections for automated driving operation of vehicles. This means that it is determined whether it is possible to drive on a certain route section during automated driving operation without malfunctions of an assistance system for automated driving operation, in particular for autonomous driving operation, occurring or the vehicle being damaged when travelling on the certain route sections, for example due to the presence of potholes.

Moreover, an embodiment provides that the driving dynamics during operation of a vehicle of the vehicle fleet is automatically adjusted accordingly based on the information ascertained about the road condition. If, for example, minor road damage is detected and automated driving operation is still possible, then acceleration and/or driving speed, for example, are adjusted to the road conditions. This information can also be used for manual driving operation of the vehicle. For example, if road damage is detected, a warning is issued in the vehicle to reduce the driving speed such that the risk of damage to the vehicle can be reduced.

Furthermore, if road damage is recognized on a route section, a responsible body is informed to repair the road damage. Once this information is available, the responsible body can take action.

Exemplary embodiments of the invention are explained in more detail below by means of drawings.

### BRIEF DESCRIPTION OF THE DRAWING FIGURES

Here are shown in:

FIG. 1, schematically, a route section, a vehicle driving on it, satellites and a central computer unit,

FIG. 2, schematically, a perspective view of a cut-out of the vehicle with different vehicle systems,

FIG. 3, schematically, a data and communication model for aligning determined road condition models, and

FIG. 4, schematically, a continuous observation of a road condition.

Parts corresponding to one another are provided with the same reference numerals in all figures.

### DETAILED DESCRIPTION

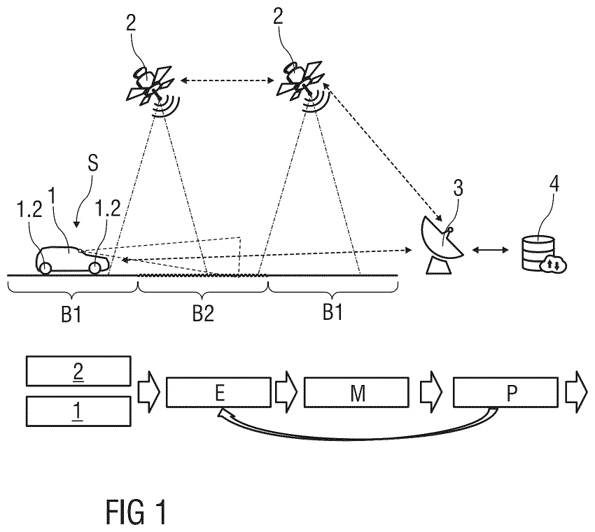

FIG. 1 shows a route section S on which a vehicle 1 is travelling. The route section S has regions B1, B2 of different quality of a surface. Furthermore, there are two satellites 2, a transmitter and receiver module 3, and a central computer unit 4 coupled to the vehicle 1 using data technology, wherein communication of the vehicle 1 with the central computer unit 4 and communication of the satellites 2 with the central computer unit 4 takes place via the transmitter and receiver module 3.

In addition, FIG. 1 shows a sequence of a method for determining a road condition in a very simplified manner.

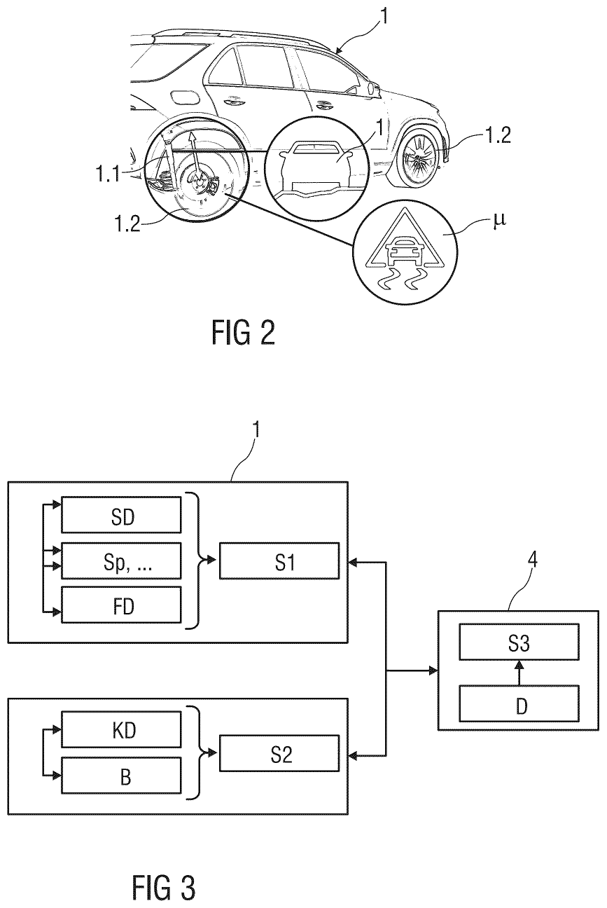

In FIG. 2, a perspective cut-out of a vehicle 1 with various suspension systems is depicted, and FIG. 3 shows a data and communication model for comparing determined road condition models S1, S2, S3.

The vehicle 1 has an assistance system, not shown in more detail, for partially or highly automated driving operation and is part of a vehicle fleet, for example of a vehicle manufacturer, wherein all vehicles in the vehicle fleet are coupled to the central computer unit 4 using data technology.

For a highly automated driving operation in particular, it is essential that the road conditions of route sections S being travelled on or to be travelled on can be precisely determined.

Factors such as a friction coefficient μ shown in FIG. 2 determine how an automated driving vehicle 1 calculates its trajectory. In addition, the required brake pressure and further factors for automated driving operation must be calculated correctly.

The present road condition is also comparatively important for manual driving operation of the vehicle 1, for example to avoid as far as possible damage to the vehicle 1 due to road damage caused by driving over it.

In general, municipalities and motorway maintenance authorities benefit if they know where black ice is prevalent and where road damage is or may occur.

The method for determining road conditions is described below, wherein the method enables road circumstances, i.e., road conditions, to be determined and predicted relatively comprehensively and with comparatively high frequency and accuracy.

The vehicle 1, i.e., the vehicles 1 of the vehicle fleet, have a sensor system with a number of sensors arranged in and/or on the vehicle 1, which are formed, for example, as cameras, lidar-based, radar-based, and/or ultrasound-based sensors. These sensors in particular record optical signals, i.e., optical sensor data SD.

Moreover, the vehicle 1 comprises a chassis sensor system for recording chassis data FD and a device for vehicle dynamics control, by means of which a slip Sp etc. is determined.

An active chassis makes it possible to determine the road condition of a route section S of a road currently being travelled on, wherein the sensor data SD, the chassis data FD, and the slip Sp determined are used for this purpose.

The satellites 2 are components of a satellite network, in particular a LEO satellite system, wherein LEO is the abbreviation for Low Earth Orbit. The satellites 2 each have a number of image sensors for capturing satellite images B, i.e., optical world data.

Satellite images B of the Earth's surface and thus of road surfaces are captured by means of the satellites 2. The recorded, i.e., captured, satellite images B are transmitted to the central computer unit 4 via the transmitter and receiver module 3. The central computer unit 4 extracts from the satellite images B image information of a respective road condition of route sections S of the respective road.

The vehicles 1 of the vehicle fleet and the satellites 2 thus carry out a recording E, i.e., a measurement, in relation to the respective road condition, wherein the recorded sensor data SD, the recorded chassis data FD, and the recorded satellite images B, in particular the extracted image information, are fed to a learning algorithm M in the form of a so-called deep learning model. By means of the learning algorithm M, a prediction P can be made with regards to future road conditions if there is a sufficient quantity of recorded data SD, FD, B.

In other words, the vehicle 1 measures using its sensor system, i.e., the optical sensors, an actuator of the chassis 1.1, and the determined slip Sp of the vehicle wheels 1.2, the road condition of the route section S currently being travelled on. The vehicle 1 then transmits the recorded or determined information to the central computer unit 4. A network of satellites 2 also measures the road conditions of route sections S.

Vehicle system states are measured, wherein the determined chassis data is compared to recorded signals of least one acceleration sensor on the vehicle. Recognizing the vehicle system states provides data about the road condition, in particular with regards to elevations and depressions in the road surface.

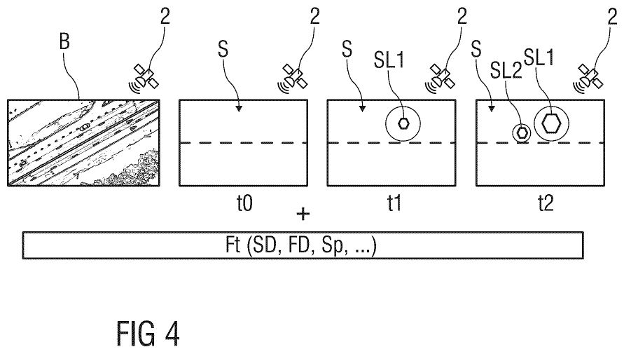

In particular, the algorithm M for predicting the road condition P is created by means of the extracted image information of the captured satellite images B. Here, an initial model, for example the deep learning model, based on reinforcement learning, is set up, which predicts the road condition by means of the satellite images B. In an iterative process, real measured fleet data Ft shown in FIG. 4 with regards to the road conditions is used by the vehicles 1 of the vehicle fleet as ground truth in order to refine and specify the algorithm M to increase reliability with respect to the prediction P of the road conditions. The reliability of the prediction P here increases for each kilometer driven by a vehicle 1 of the vehicle fleet.

The real measured data SD, FD, Sp of the vehicles 1 of the vehicle fleet, i.e., the real fleet data Ft, can optimize the robustness of the algorithm M and reduce a number of incorrectly detected road damages of the satellites 2.

According to FIG. 3, a road condition model S1 is created by means of the sensor data SD, the slip Sp and the chassis data FD, which are compared and verified with one another.

A further road model S2 is created by means of the satellite images B and digital map data KD, which are allocated and compared to each other.

By means of these two road condition models S1, S2, the central computer unit 4 creates a synchronized road condition model S3, which is extended with further data D, for example map data KD.

Corresponding communication and verification here takes place between satellite 2 and central computer unit 4 with regards to the further road condition model S2 and the synchronized road condition model S3.

Communication also takes place between the vehicle 1 and the central computer unit 4 with regards to the road condition model S1 and the synchronized road condition model S3.

This synchronized road condition model S3 depicts the road condition of the respective route section S of a road.

FIG. 4 shows a continuous observation of a route section S by means of recorded satellite images B of a satellite 2 or one or more satellites 2.

At a point in time t0, the route section S is recorded without road damage, in particular without pothole SL1, SL2. At a second point in time t1, a comparatively small pothole SL1 is detected, whereas this pothole SL1 is comparatively large at a third point in time t2 and a second pothole SL2 has formed on the route section S.

Road damage can be recognized via a temporal sequence of the recorded fleet data Ft and an allocation of this to the image information of the satellite images B. Thus, future road damage can be predicted by means of the algorithm M with sufficient data.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for determining a road condition comprising:
receiving, by a central computer unit, satellite images of Earth's surface;
extracting, by the central computer unit using digital map data, image information of road surfaces from the received satellite images; and
determining, using a learning algorithm, a road condition of route sections of a respective road from the extracted image information of the road surfaces,
wherein vehicles of a vehicle fleet are connected to the central computer unit using data technology.

12. The method of claim 11, further comprising:
training the learning algorithm using ground truth data recorded by the vehicles of the vehicle fleet as the vehicles of the vehicle fleet travel along a respective section of the route sections; and
transmitting the ground truth data to the central computer unit.

13. The method of claim 11, further comprising:
determining a real road condition using detected signals of a sensor system of a respective vehicle of the vehicle fleet.

14. The method of claim 11, further comprising:
determining a real road condition using recorded vehicle system states of a respective vehicle of the vehicle fleet.

15. The method of claim 11, further comprising:
determining a friction coefficient of a respective route section of the route section using a detected slip of a driven vehicle wheel of a respective vehicle of the vehicle fleet.

16. The method of claim 11, further comprising:
creating a road condition model using fleet data of the vehicles of the vehicle fleet;
creating a further road condition model using the satellite images; and
creating a synchronized road condition model using the road condition model, the further road condition model, and further data.

17. The method of claim 16, further comprising:
providing, by the central computer unit, the synchronized road condition model to the vehicles of the vehicle fleet.

18. The method of claim 11, further comprising:
determining, using the determined road condition, whether to release or block one or more route sections of the route sections for automated driving operation of vehicles.

19. The method of claim 11, further comprising:
automatically adjusting driving dynamics during operation of a vehicle of the vehicle fleet based on information determined about the road conditions.

20. The method of claim 11, further comprising:
notifying a body responsible for repairing a road of road damage when road damage is detection on a route section of the route sections.
